(19) United States
(12) Patent Application Publication
(10) Pub. No.: US 2017/0021468 A1
(43) Pub. Date: Jan. 26, 2017

(54) Hydraulic Pressure Resistant Adaptor

(71) Applicant: Ching-Ting Chen, Taichung City (TW)

(72) Inventor: Ching-Ting Chen, Taichung City (TW)

(21) Appl. No.: 14/808,218

(22) Filed: Jul. 24, 2015

(51) Int. Cl. B23Q 11/10; B23B 31/02

(52) U.S. Cl. CPC B23Q 11/1023; B23B 31/02

(57) ABSTRACT

An adaptor has a conjunction section and an abutting portion; wherein the abutting portion is axially connected to the conjunction section. The conjunction section has an external surface, a conduction recess, and an inlet hole. The conduction recess is defined in the external surface of the conjunction section and has a bottom face. The inlet hole is defined through the bottom face. The abutting portion has a cutter holder through hole defined through the abutting portion to assemble a cutter holder. The adaptor can be applied on a tool magazine, and the tool magazine has a rotary changer that supplies cutting fluid.

### BACKGROUND OF THE INVENTION

1. Field of the Invention

The present invention relates to a machine tool, and more particularly to an adaptor that can keep the piping for cutting fluid from being exposed.

2. Description of Related Art

With the reference to FIG. 4, FIG. 5, and FIG. 6, a tool magazine assembly 80 applied to a lathe comprises a rotary tool changer 81, a fixing seat 82, an adaptor 83, a cutter holder 84, a cutter 85, and a conduction pipe 86. The fixing seat 82 is assembled on the rotary tool changer 81. The rotary tool changer 81 and the fixing seat 82 have inner pipes respectively. The rotary tool changer 81 and the fixing seat 82 communicate with each other via these inner pipes. The adaptor 83 is a sleeve having a conjunction section 831 and an abutting portion 832. The conjunction section 831 has an outer diameter and a fastening bolt through hole 8311 which is axially defined through the conjunction section 831. The abutting portion 832 is axially connected to the conjunction section 831 and has an outer diameter, a cutter holder through hole 8321, and a connecting hole 8322. The cutter holder through hole 8321 is defined through the abutting portion 832 and axially communicates with the fastening bolt through hole 8311. The connecting hole 8322 is defined in the abutting portion 832 in a radial direction of the abutting portion 832 and communicates with the cutter holder through hole 8321. The outer diameter of the abutting portion 832 is larger than the outer diameter of the conjunction section 831. The adaptor 83 is mounted in the fixing seat 82. The cutter holder 84 is mounted into the cutter holder through hole 8321 of the adaptor 83. The cutter 85 is mounted into the cutter holder 84. The conduction pipe 86 is linked to the connecting hole 8322 of the adaptor 83 and the fixing seat 82, so the fixing seat 82 and the adaptor 83 are connected to each other by the conduction pipe 86.

The cutting fluid supplied by the rotary tool changer 81 is led into the fixing seat 82 by the inner pipes and then is led into the adaptor 83 through the conduction pipe 86. The cutting fluid in the adaptor 83 is led into the cutter holder 84 and then discharged from two spiral channels defined in the cutter 85 to lubricate and cool the cutter 85.

The cutting fluid is led into the conventional adaptor 83 through the conduction pipe 86 attached to the connecting hole 8322. Since the cutting fluid is conducted by the exposed conduction pipe 86, the exposed conduction pipe 86 may be easily broken by the sprayed scraps produced during the cutting process. In addition, the conduction pipe 86 is easily detached from the fixing seat 82 or the adaptor 83 due to the exceeding hydraulic pressure of the cutting fluid. And the conduction pipe 86 disposed exteriorly may interfere with other parts of the tool magazine assembly 80 during operation of the rotary tool changer 81.

To overcome the shortcomings of the conventional adaptor, the present invention provides a hydraulic pressure resistance adaptor to mitigate or obviate the aforementioned problems.

### SUMMARY OF THE INVENTION

The main objective of the present invention is to provide a hydraulic pressure resistance adaptor that can bear high hydraulic pressure.

The adaptor has a conjunction section and an abutting portion; wherein the abutting portion is axially connected to the conjunction section. The conjunction section has an external surface, a conduction recess, and an inlet hole. The conduction recess is defined in the external surface of the conjunction section and has a bottom face. The inlet hole is defined through the bottom face. The abutting portion has a cutter holder through hole defined through the abutting portion to assemble a cutter holder. The adaptor can be applied on a tool magazine, and the tool magazine has a rotary changer that supplies cutting fluid. With the conduction recess and the inlet hole defined in the adaptor, the problems that an exposed pipe is detached due to exceeding hydraulic pressure of the cutting fluid, is easily broken by scraps, and easily interferes with other components during the operation of the tool magazine can all be solved.

Other objects, advantages, and novel features of the invention will become more apparent from the following detailed description when taken in conjoint with the accompanying drawings.

### BRIEF DESCRIPTION OF THE DRAWINGS

FIG. 1 is a perspective view of a hydraulic pressure resistance adaptor in accordance with the present invention;

FIG. 2 is a cross sectional perspective view of the hydraulic pressure resistance adaptor in FIG. 1;

FIG. 3 is a side view in partial section of a tool magazine assembly comprising the hydraulic pressure resistance adaptor in FIG. 1;

FIG. 4 is a perspective view of a tool magazine assembly comprising a conventional adaptor;

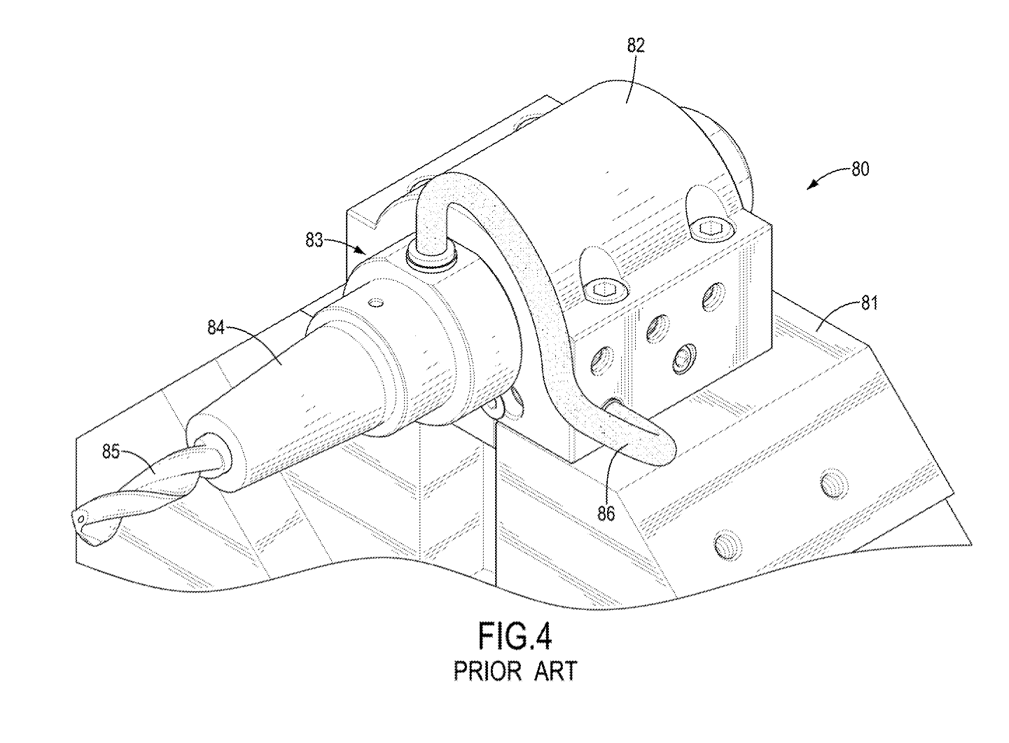

FIG. 5 is a side view in partial section of the tool magazine assembly comprising the conventional adaptor in FIG. 4; and

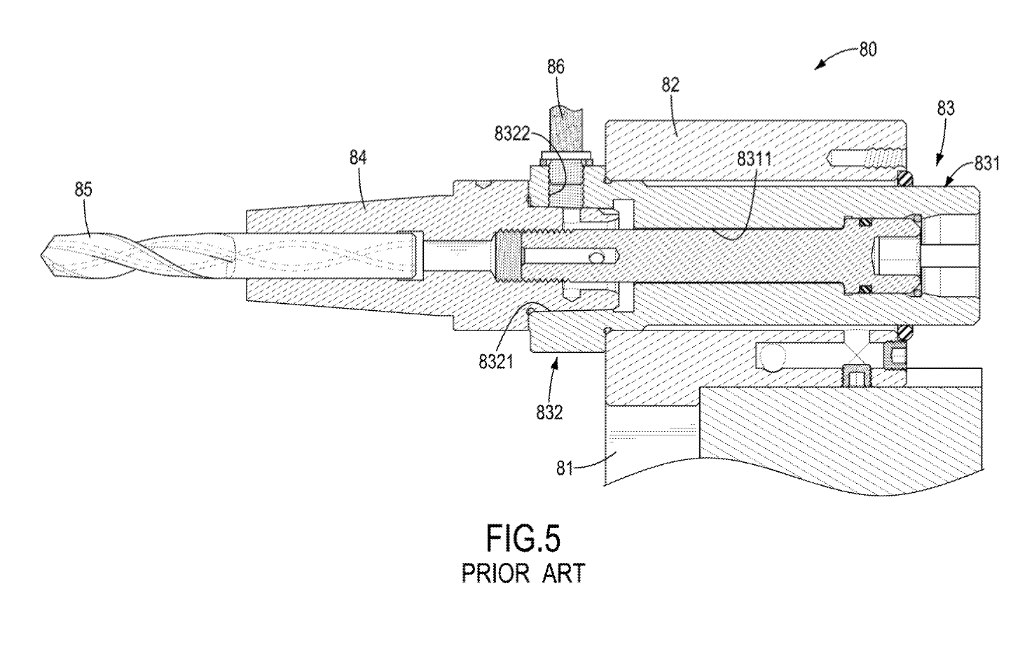

FIG. 6 is a perspective view of the conventional adaptor in FIG. 4.

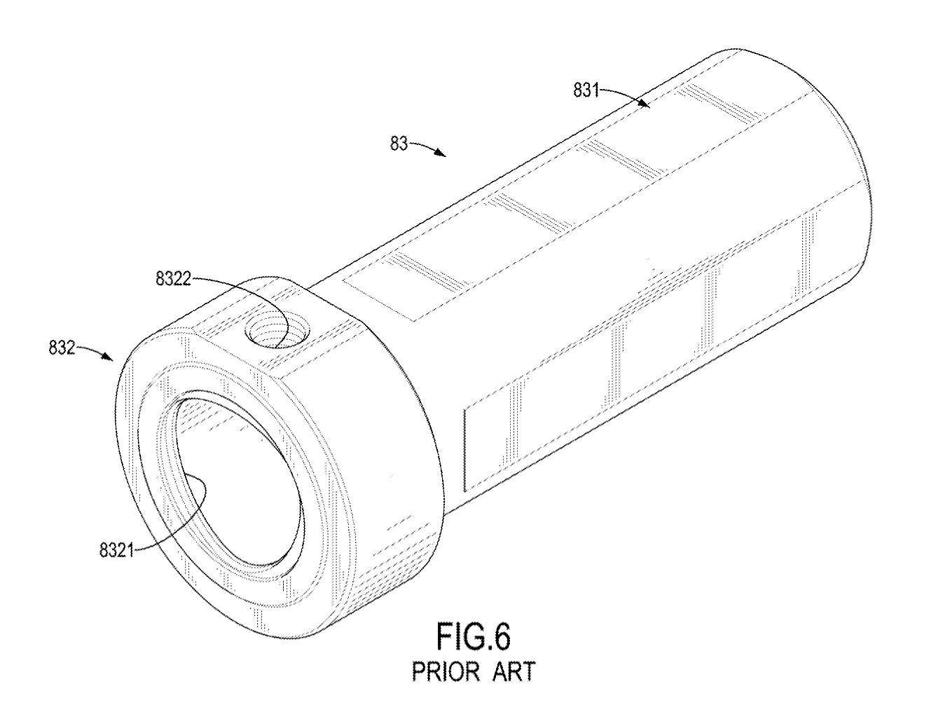

### DETAILED DESCRIPTION OF PREFERRED EMBODIMENT

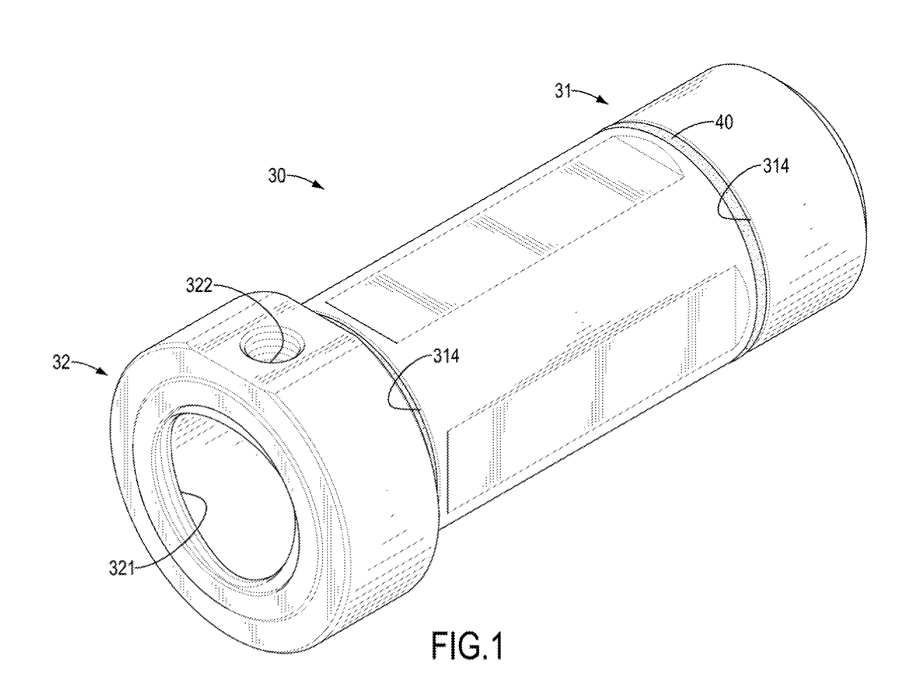

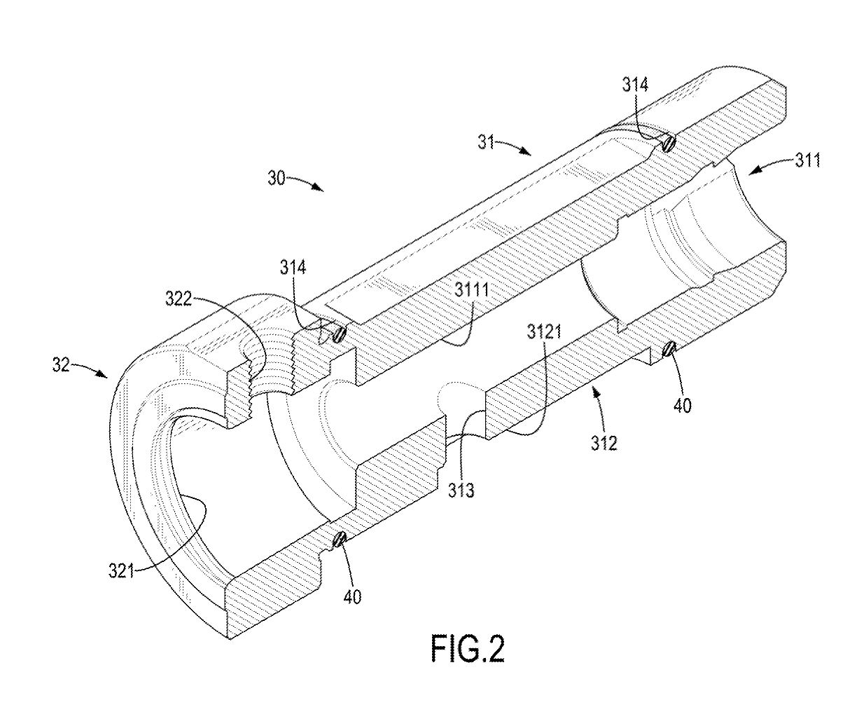

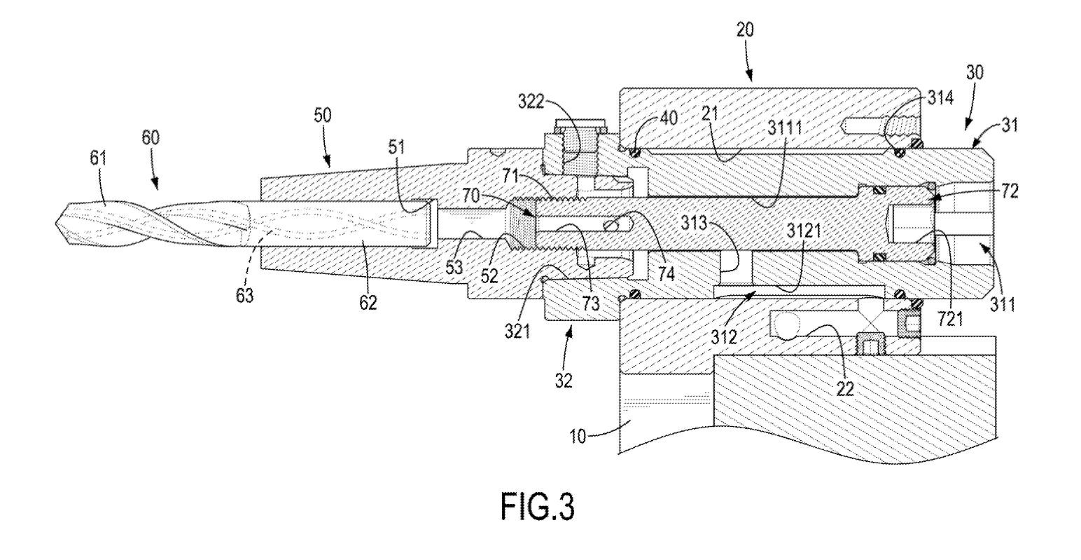

With reference to FIG. 1, FIG. 2 and FIG. 3, an adaptor 30 of the present invention is mounted on a tool magazine. The tool magazine assembly comprises a rotary tool changer 10, a fixing seat 20, the adaptor 30, two seals 40, a cutter holder 50, a cutter 60, and a fastening bolt 70. The fixing seat 20 is assembled on the rotary tool changer 10. The adaptor 30 is assembled on the fixing seat 20. The two seals 40 are assembled on the adaptor 30. The cutter holder 50 is assembled on the adaptor 30. The cutter 60 is assembled on the cutter holder 50. The fastening bolt 70 is inserted in the adaptor 30 and is screwed with the cutter holder 50.

With reference to FIG. 1 and FIG. 2, the rotary tool changer 10 comprises inner pipes which supply cutting fluid for cooling and lubricating the cutter 60. The fixing seat 20 is assembled on the rotary tool changer 10 and comprises an adaptor through hole 21 and multiple channels 22. The adaptor through hole 21 is laterally defined through the fixing seat 20 and has a diameter. The multiple channels 22 communicate with the inner pipes of the rotary tool changer 10 and the adaptor through hole 21.

With reference to FIG. 1 and FIG. 2, the adaptor 30 is a sleeve having a conjunction section 31 and an abutting portion 32. The conjunction section 31 has two ends, an external surface, an outer diameter, a fastening bolt through hole 311, a conduction recess 312, an inlet hole 313, and two grooves 314. The fastening bolt through hole 311 is axially defined through the conjunction section 31 and has an inner surface. The inner surface of the fastening bolt through hole 311 has a fastening bolt abutting portion 3111 which is an annular protrusion formed on the inner surface of the fastening bolt through hole 311. The fastening bolt abutting portion 3111 has an inner diameter. The conduction recess 312 is defined radially in the external surface of the conjunction section 31 and has a bottom face 3121. The inlet hole 313 is defined through the bottom face of the conduction recess 312 and communicates with the fastening bolt through hole 311. The two grooves 314 are formed around the external surface of the conjunction section 31 and are disposed at the two ends of the conjunction section 31 respectively. The abutting portion 32 is axially connected to the conjunction section 31 and has an external surface, a cutter holder through hole 321, and a connecting hole 322. The cutter holder through hole 321 is axially defined through the abutting portion 32 and communicates with the fastening bolt through hole 311. The cutter holder through hole 321 has a cross section, and the cross section of the cutter holder through hole 321 is triangular pyramid-shaped and matches a triangular pyramid-shaped cutter holder. The connecting hole 322 is defined in the abutting portion 32 in a radial direction of the abutting portion 32 and communicates with the cutter holder through hole 321. The conjunction section 31 of the adaptor 30 is inserted in the adaptor through hole 21 of the fixing seat 20.

The two seals 40 are made of flexible material and are mounted in the two grooves 314 of the adaptor 30 respectively.

With reference to FIG. 1 and FIG. 2, the cutter holder 50 has two ends, a cutter through hole 51, a threaded hole 52, and a passage 53. The cutter through hole 51 is axially defined in one of the ends of the cutter holder 50 and has a diameter. The threaded hole 52 is axially defined in the other end of the cutter holder 50 and has an inner thread. The passage 53 is axially defined in the cutter holder 50 and communicates with the cutter through hole 51 and the threaded hole 52. The cutter holder 50 is mounted in the cutter holder through hole 321 of the adaptor 30 at the end that has the threaded hole 52.

With reference to FIG. 1 and FIG. 2, the cutter 60 has two ends, a cutting portion 61, an assembling portion 62, and two cutting fluid passages 63. The cutting portion 61 is spiral and is disposed at one of the ends of the cutter 60. The assembling portion 62 is disposed at the other end of the cutter 60 and has a diameter equal to the diameter of the cutter through hole 51. The two cutting fluid passages 63 are spirally defined in the cutter 60 and extend through the two ends of the cutter 60. The assembling portion 61 of the cutter 60 is inserted in the cutter through hole 51 of the cutter holder 50.

With reference to FIG. 1 and FIG. 2, the fastening bolt 70 has two ends, an outer thread 71, a blocking portion 72, a cutting fluid conduction hole 73, and a communicating hole 74. The outer thread 71 and the blocking portion 72 are disposed at the two ends of the fastening bolt 70 respectively. The outer thread 71 is engaged with the inner thread of the threaded hole 52.

The blocking portion 72 has an outer diameter, an end face, and a socket 721. The outer diameter of the blocking portion 72 is larger than the inner diameter of the fastening bolt abutting portion 3111. The socket 721 is defined in the end face of the blocking portion 72 and has a cross section, and the cross section of the socket 721 is hexagonal. The cutting fluid conduction hole 73 is axially defined in the fastening bolt 70 at the end opposite to the end surface. The cutting fluid conduction hole 73 and the outer thread 71 are disposed at the same end of the fastening bolt 70. The communicating hole 74 is defined through the fastening bolt 70 in a radial direction of the fastening bolt 70. The communicating hole 74 communicates with the cutting fluid conduction hole 73. The fastening bolt 70 is inserted in the adaptor 30 and is screwed with the cutter holder 50 by the outer thread 71 and the threaded hole 52, and the blocking portion 72 abuts the fastening bolt abutting portion 3111. To dismantle the cutter holder 50, a hex wrench is inserted in the socket 721 and turned. The fastening bolt 70 can be screwed out of the threaded hole 52 to disengage the cutter holder 50 from the adaptor 30.

With reference to FIG. 3, the cutting fluid supplied by the rotary tool changer 10 is led to enter the channels 22 of the fixing seat 20. Then, the cutting fluid fills up the conduction recess 312. The two seals 40 assembled in the two grooves 314 of the adaptor 30 can prevent the cutting fluid from leaking. The cutting fluid in the conduction recess 312 flows through the inlet hole 313 and then enters a gap between the adaptor 30 and the fastening bolt 70. The cutting fluid flows through the communicating hole 74, enters the cutting fluid conduction hole 73, and then enters the passage 53 of the cutter holder 50. Finally, the cutting fluid enters the two cutting fluid passages 63.

The conduction recess 312 and the inlet hole 313 provided by the adaptor 30 in accordance with the present invention enable the cutting fluid to pass through the adaptor 30 and to enter the fastening bolt 70, then to flow into the cutter holder 50 and to be discharged from the two cutting fluid passages 63 of the cutter 60 to achieve the function of cooling and lubricating the cutter 60. Compared with the conventional adaptor, the adaptor 30 in accordance with the present invention can bear the hydraulic pressure of the cutting fluid above 70 kg/cm² and can avoid damage done by scraps and interference with other parts during operation of the rotary tool changer 10.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An adaptor comprising:
a conjunction section being rod-shaped and having
two ends;
an external surface;
an outer diameter;
a fastening bolt through hole axially defined through the conjunction section;
a conduction recess defined in the external surface of the conjunction section in a radial direction of the conjunction section and having a bottom face; and
an inlet hole in the radial direction of the conjunction section and connected with the fastening bolt through hole; and
an abutting portion axially connected to one of the two ends of the conjunction section which is proximal to the inlet hole and having
an outer diameter;
a cutter holder through hole axially defined through the abutting portion and connected with the fastening bolt through hole.

2. The adaptor as claimed in claim 1, wherein the conjunction section has two grooves defined around the external surface of the conjunction section, and the two grooves are disposed at the two ends of the conjunction section respectively.

3. The adaptor as claimed in claim 2 further comprising two seals mounted respectively in the two grooves.

4. The adaptor as claimed in claim 3, wherein the abutting portion has a connecting hole defined in the abutting portion in a radial direction of the abutting portion and connected with the cutter holder through hole.

5. The adaptor as claimed in claim 4, wherein the cutter holder through hole is triangular pyramid-shaped.

6. The adaptor as claimed in claim 5, wherein the fastening bolt through hole has
an inner surface; and
an annular fastening bolt abutting portion formed on the inner surface of the fastening bolt through hole.
